(19) United States
(12) Patent Application Publication
(10) Pub. No.: US 2026/0062869 A1
(43) Pub. Date: Mar. 5, 2026

(54) Apparatus and method for dry forming cellulose products

(71) Applicant: Fameccanica.Data S.p.A., San Giovanni Teatino Chieti (IT)

(72) Inventors: Alessandro CIPRIANI, San Giovanni Teatino Chieti (IT); Diego GUALTIERI, San Giovanni Teatino Chieti (IT)

(21) Appl. No.: 19/314,441

(22) Filed: Aug. 29, 2025

(30) Foreign Application Priority Data
Sep. 3, 2024 (IT) 102024000019645

(51) Int. Cl. D21J 5/00

(52) U.S. Cl. CPC D21J 5/00

(57) ABSTRACT

An apparatus for dry forming of blanks of cellulose products including a forming wheel having an outer surface provided with a plurality of discrete forming seats, and a system for adding alkyl ketene dimer (AKD) to the blanks of cellulose products.

### FIELD OF THE INVENTION

The present invention relates in general to the production of cellulose products.

More specifically, the invention concerns an apparatus and a method for dry forming cellulose products.

The invention was developed in particular for producing soluble beverage capsules or container caps.

However, the invention is not limited to this specific field and can be used for producing a wide range of two-dimensional or three-dimensional products, such as containers, boxes, disposable plates, cups, packaging products for solid or liquid goods, and other types of disposable articles.

### BACKGROUND OF THE INVENTION

Many disposable articles, such as soluble beverage capsules, container caps, packaging products etc., are still made from plastic materials that have significant energy and environmental impacts both in their production and recycling. There is therefore a strong need for sustainable products that are recyclable in the paper chain.

Products formed from cellulose fibers can be used in many cases where disposable articles with greater sustainability than plastic products need to be produced.

Recently, new processes have been developed for dry forming of three-dimensional products consisting of cellulose fibers.

The current prior art solutions for manufacturing cellulose products using dry-molding technology involve a mill that defibrates a cellulose sheet. The defibrated cellulose is typically conveyed onto a forming belt where a mat of cellulose fibers with uniform thickness and variable width, generally around 600 mm, is formed. The forming belt and the cellulose fiber mat advance at constant speed. The cellulose fiber mat, which may have basis weights in the range of 300-900 gsm, is coupled with two tissue paper layers placed on opposite sides of the cellulose fiber mat. Then, a spray additive application phase is performed with liquid additives, such as AKD, latex, etc., in water solution at 5-20% concentration. Subsequent steps include calendering to the most uniform thickness possible, die cutting, and pressing which are performed in intermittent and indexed mode. Between the continuous forming phase and the indexed pressing, a buffer consisting of a variable-sized loop is formed. The are generated through three-dimensional pressing of a flat starting material with uniform thickness.

WO2021001276A1 describes a method producing cellulose products, comprising the steps of providing a raw cellulose structure, applying in a first application phase an alkyl ketene dimer (AKD) dispersion to the raw cellulose structure, and applying in a second application phase subsequent to the first application phase a latex dispersion to the raw cellulose structure, arranging the raw cellulose structure with the AKD dispersion and latex dispersion in a forming mold, heating the raw cellulose structure with the AKD dispersion and latex dispersion to a forming temperature between 100° C. and 300° C., and forming the cellulose product from the raw cellulose structure with the AKD dispersion and latex dispersion in the forming mold, pressing the heated raw cellulose structure with the AKD dispersion and latex dispersion with a forming pressure of at least 1 MPa, preferably 4-20 MPa.

Alkyl ketene dimers (AKD) are a family of organic compounds based on a 4-membered ring system of oxetan-2-one, which is also the central structural element of propiolactone and diketene. To the oxetane ring of technically relevant alkyl ketene dimers is attached a C12-C16 alkyl group at position 3 and a C13-C17 alkylidene group at position 4.

The main application of alkyl ketene dimers (AKD) is in the sizing of paper and cardboard, as well as in the hydrophobization of cellulose fibers. Products modified in this way are characterized by greater mechanical strength and reduced penetration of water, inks or printing inks.

In cellulose products formed with the method described in WO2021001276, the AKD dispersion and latex dispersion form a barrier structure that prevents the absorption of water or other liquids by the cellulose fiber products. This way, the cellulose products resist contact with liquids, foods and other substances for longer periods without altering the mechanical properties of the cellulose products.

One problem of the prior art is that the raw cellulose structure with the applied AKD dispersion and latex dispersion has high moisture content and is very sticky. The raw cellulose structure thus formed tends to adhere to the mechanical components it comes into contact with and contaminates the forming mold and the embossing and cutting units used to give the raw cellulose structure the desired shape.

Moreover, high moisture content of the raw cellulose structure during the pressing phase can compromise product quality. Specifically, moisture can affect thickness, stiffness, compaction, density and surface uniformity of the finished products.

### OBJECT AND SUMMARY OF THE INVENTION

The object of the present invention is to provide an apparatus and method for dry forming cellulose products that overcome the problems of the prior art.

According to the present invention, this object is achieved by an apparatus of 1 and a method according to claim 7.

Preferred embodiments of the invention form the subject of the dependent claims.

The claims form an integral part of the teaching provided in relation to the invention.

### BRIEF DESCRIPTION OF THE DRAWINGS

The present invention will now be described in detail with reference to the accompanying drawings, given by way of non-limiting example only, in which:

FIG. 1 is a schematic side view of a first embodiment of an apparatus for dry forming cellulose products,

FIG. 2 is a schematic side view of a second embodiment of an apparatus for dry forming cellulose products,

FIGS. 3-8 are schematic views of different embodiments of a powder product dispenser usable in an apparatus for dry forming cellulose products,

FIG. 9 is a schematic view of a further embodiment of a powder product dispenser usable in an apparatus for dry forming cellulose products.

It will be appreciated that the accompanying drawings are schematic and some components may not be shown to simplify understanding of the figures.

### DETAILED DESCRIPTION

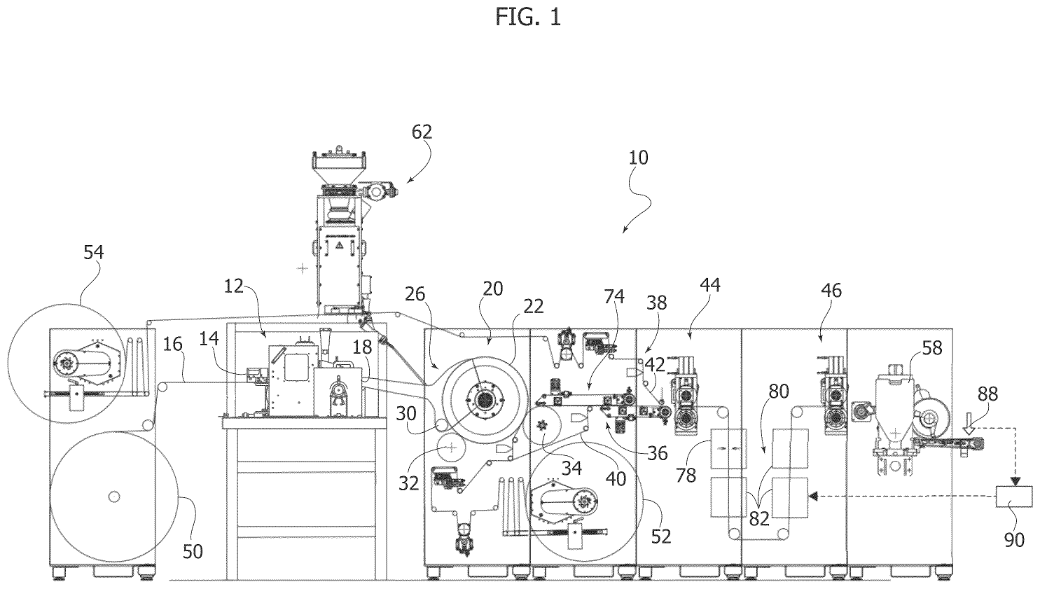

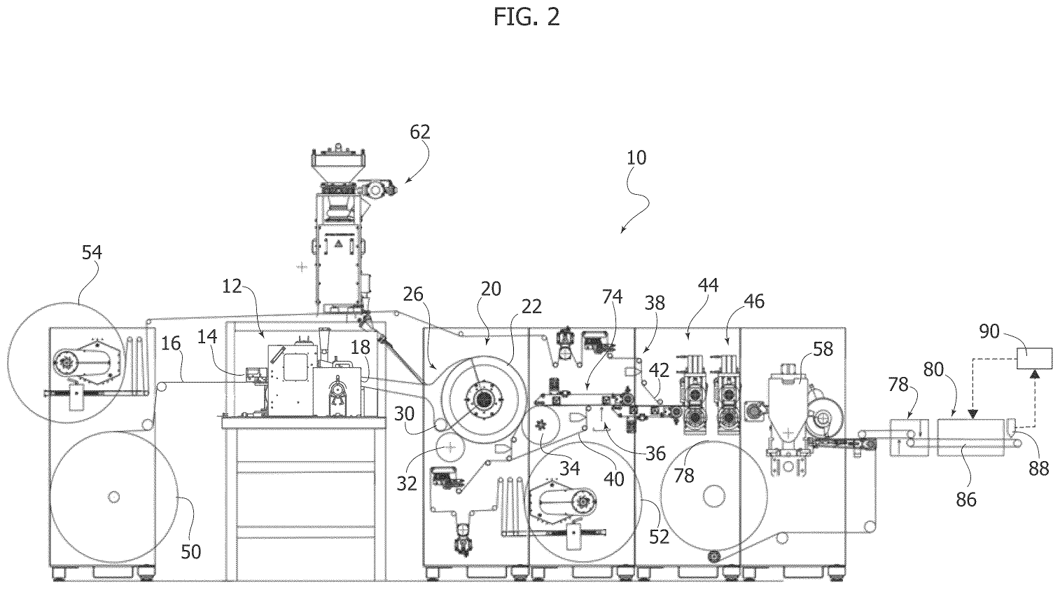

With reference to FIGS. 1 and 2, reference numeral 10 indicates an apparatus for dry forming cellulose products.

The apparatus 10 includes a defibrating mill 12 for defibrating cellulose sheets. Defibrating mills are generally used to convert sheets of fibrous material, such as paper or cardboard sheets, into a dispersion of loose fibers. Defibrating mills are typically employed for producing cellulose fluff, used as absorbent mass in production lines for absorbent sanitary articles.

The defibrating mill 12 may be a disc mill, including a support housing having a cavity inside which a rotor comprising a pack of toothed discs is rotatably mounted.

The defibrating mill 12 has an inlet section 14 configured to receive a cellulose sheet 16 unwound from a reel 50 and an outlet section 18 configured to provide a flow of loose cellulose fibers.

The apparatus 10 includes a forming wheel 20 rotatable about a rotation axis. The forming wheel 20 has an outer surface 22 provided with a plurality of discrete forming seats configured for forming blanks of cellulose products. The discrete forming seats may be formed, for example, as described in Italian patent application No. 102024000018082 by the same Applicant.

The apparatus 10 includes a fiber deposition chamber 26 configured to receive a flow of loose cellulose fibers from the outlet section 18 of the defibrating mill 12. The fiber deposition chamber 26 faces a sector of the outer surface 22 of the forming wheel 20 and is configured for depositing loose cellulose fibers into the discrete forming seats of the forming wheel 20. An air flow may be fed into the fiber deposition chamber 26 to convey the loose cellulose fibers toward the discrete forming seats of the forming wheel 20.

The discrete forming seats replicate the negatives of the blanks of cellulose products to be produced. The discrete forming seats of the forming wheel 20 may be connected to a suction source to retain the loose cellulose fibers within the respective seats by suction.

The apparatus 10 may include a leveling roller 30 rotatable about a rotation axis parallel to the rotation axis of the forming wheel 20. The leveling roller 30 cooperates with the outer surface 22 of the forming wheel 20 and is located in a terminal section of the fiber deposition chamber 26.

The effect of suction inside the discrete forming seats combined with the presence of the leveling roller 30 that removes excess cellulose fibers allows proper filling of the discrete forming seats and formation of blanks of cellulose products with correct basis weight distribution.

The apparatus 10 may include a pressing wheel 32 located downstream of the fiber deposition chamber 26, rotationally driven in phase with the forming wheel 20 and configured to perform pressing of the loose cellulose fibers in the discrete forming seats.

This feature allows pre-compaction of the fibers before transferring the blanks of cellulose products to other phases of the production process. This provides greater stability of the cellulose products formed from the blanks at the outlet of the apparatus 10, preventing product deformation during transfer phases.

In one embodiment, the apparatus 10 includes at least one dispenser device 62 configured to dispense at least one flow of AKD powder. In operation, the AKD powder flow is transported by the dispenser device 62 to the fiber deposition chamber 26 via at least one air flow.

In the fiber deposition chamber 26, the AKD powder flow is mixed with the loose cellulose fibers coming from the outlet section 18 of the defibrating mill 12.

The fiber deposition chamber 26 may include at least one mixing device that promotes mixing of the AKD powder with the loose cellulose fibers. The mixing device may comprise, for example, a rotating brush, a system of movable paddles, one or more air jets. The mixing device may be arranged inside the fiber deposition chamber 26 or on the side walls of the fiber deposition chamber 26.

In operation, the loose cellulose fibers mixed with AKD powder contained in the fiber deposition chamber 26 are deposited in the discrete forming seats to form discrete blanks of cellulose products including loose cellulose fibers mixed with AKD powder.

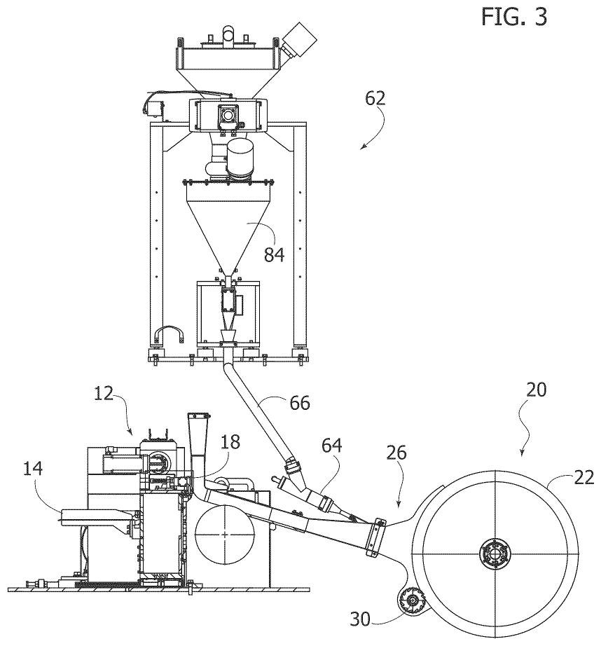

With reference to FIG. 3, in one embodiment the apparatus 10 may include at least one ejector 64 configured to introduce at least one flow of AKD powder into the fiber deposition chamber 26 through at least one powder feed conduit 66. The dispenser device 62 may include a hopper 84 having an outlet section connected to the powder feed conduit 66.

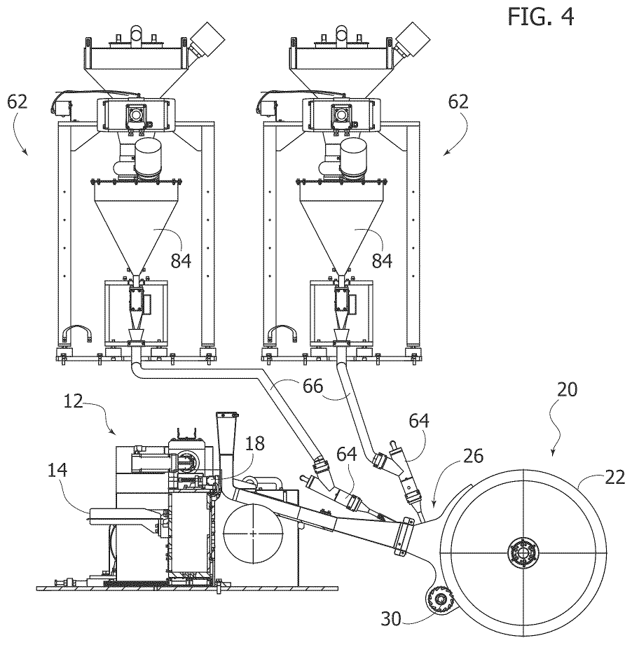

With reference to FIG. 4, in one embodiment the apparatus 10 may include a plurality of ejectors 64 configured to introduce respective flows of AKD powder into different zones of the fiber deposition chamber 26.

In one embodiment, the apparatus 10 may include a plurality of dispenser devices 62 configured to dispense respective flows of AKD powder and associated with respective ejectors 64. In this way, different types of AKD powder can be dispensed into the fiber deposition chamber 26.

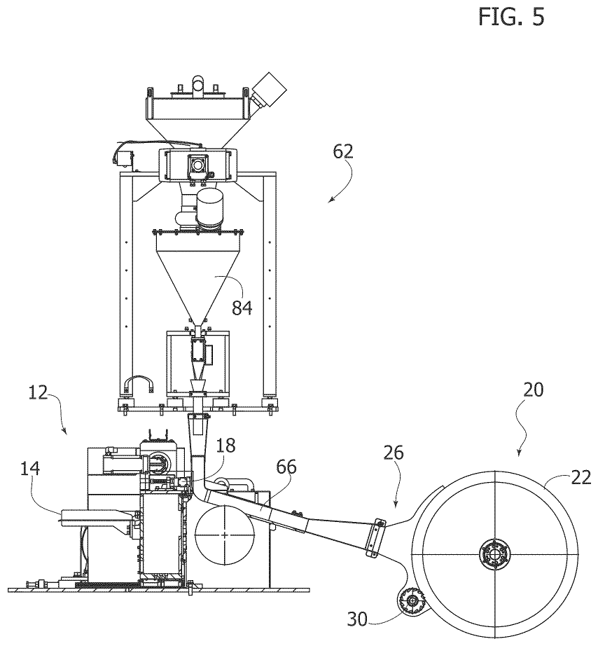

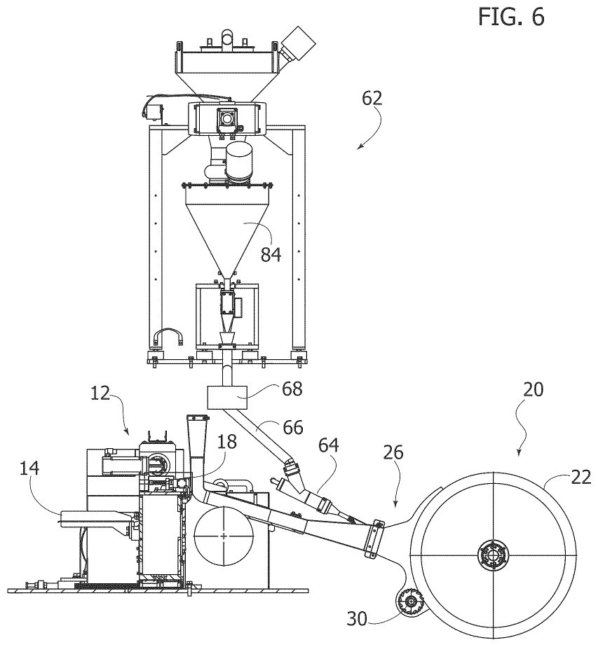

With reference to FIG. 5, in one embodiment the AKD powder flow may be transported into the fiber deposition chamber 26 by an air flow coming from the outlet section 18 of the defibrating mill 12 without the use of ejectors. With reference to FIG. 6, in one embodiment the dispenser device 62 may include a valve element 68 configured to intermittently dispense metered quantities of AKD powder. This allows the AKD powder flow to be introduced into the fiber deposition chamber 26 in phase with the angular position of the forming wheel 20.

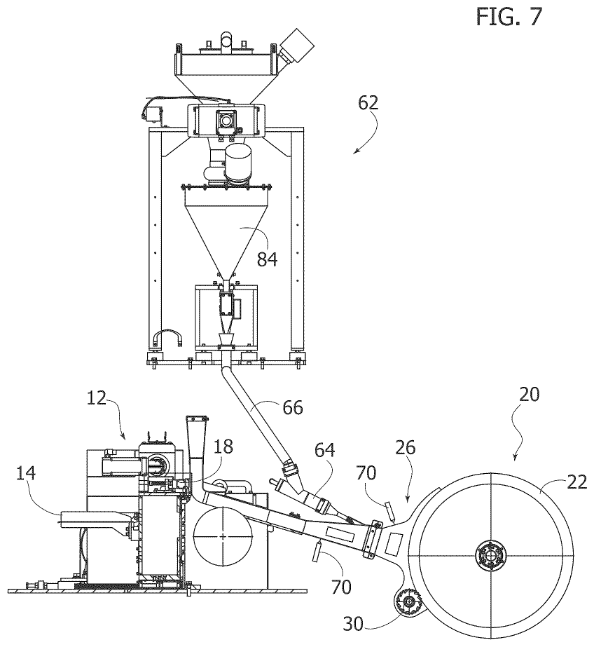

With reference to FIG. 7, in one embodiment the apparatus 10 may include a plurality of nozzles 70 configured to introduce respective air jets into the fiber deposition chamber 26 for mixing loose cellulose fibers and AKD powder.

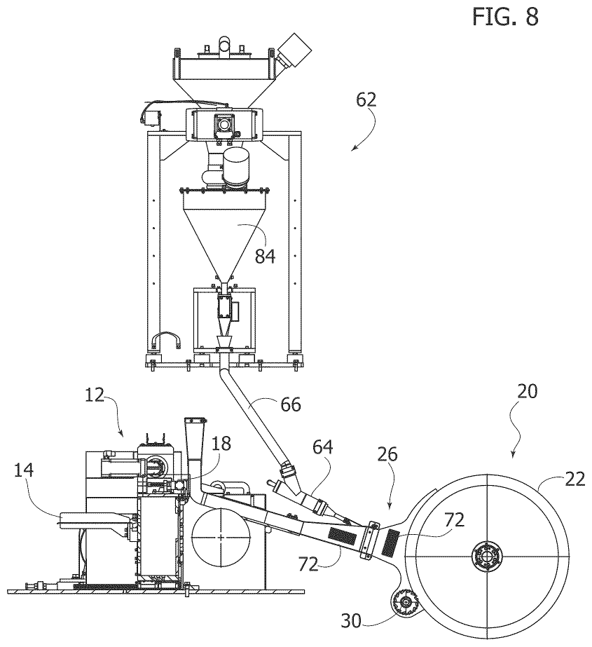

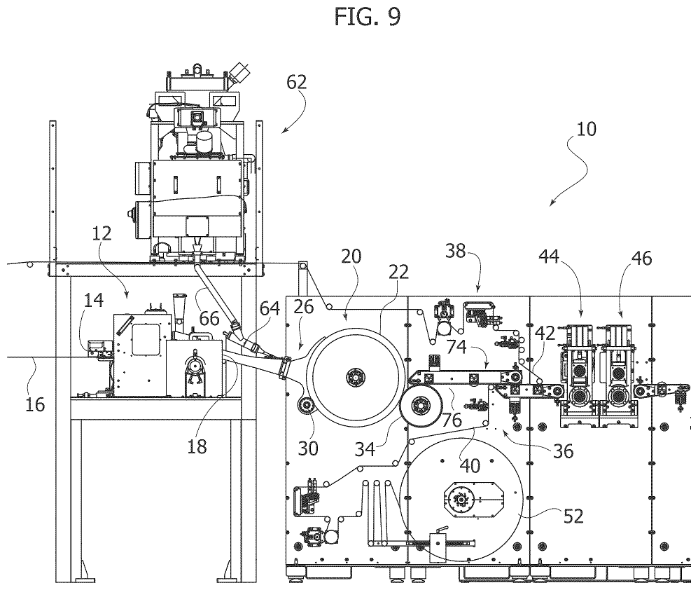

With reference to FIG. 8, in one embodiment the apparatus 10 may include a plurality of ventilation windows 72 configured to introduce air flows into the fiber deposition chamber 26 for mixing loose cellulose fibers and AKD powder.

With reference to FIGS. 1 and 2, in one embodiment the apparatus 10 includes a transfer conveyor 74 configured to receive an array of blanks of cellulose products from the forming wheel 20 and an applicator device 76 configured to apply molten AKD onto the array of blanks of cellulose products moving along the transfer conveyor 74. The applicator device 76 may be similar to devices used for applying hot melt glue onto moving webs, and may include melters, pumps, conduits and dispensing nozzles.

In one embodiment the applicator device 76 may be configured to apply molten AKD onto the array of blanks of cellulose products in continuous mode.

In one embodiment the applicator device 76 may be configured to apply molten AKD onto the array of blanks of cellulose products in intermittent mode, in phase with discrete blanks of cellulose products.

In one embodiment the apparatus 10 may include a cooling device configured to cool molten AKD applied onto the array of blanks of cellulose products.

In one embodiment the apparatus 10 may include a detachment wheel 34 tangent to the outer surface 22 of the forming wheel 20 and rotatable about a rotation axis parallel to the rotation axis of the forming wheel 20, configured to detach blanks of cellulose products from respective discrete forming seats and to feed the blanks of cellulose products to the transfer conveyor 74.

In one embodiment the apparatus 10 may include first and second feeding devices 36, 38 configured to feed first and second tissue paper layers 40, 42 on opposite sides of the array of blanks of cellulose products. The first and second tissue paper layers 40, 42 may be applied to the array of blanks of cellulose products downstream of the applicator device 76. The first and second tissue paper layers 40, 42 are unwound from respective reels 52, 54.

With reference to FIGS. 1 and 2, in one embodiment the apparatus 10 may include a spraying device 78 configured to spray AKD in aqueous solution onto the array of blanks of cellulose products coming from the forming wheel 20 and a drying device 80 located downstream of the spraying device 78 and configured to dry the array of blanks of cellulose products to a predetermined dryness level.

The spraying device 78 may include nozzles that continuously spray the AKD aqueous solution mixture from opposite sides of the array of blanks of cellulose products so as to uniformly cover the opposite surfaces of the array. The spraying device 78 may be enclosed in a containment housing to prevent environmental dispersion of the AKD aqueous solution mixture.

The drying device 80 may use hot air or contact with a heated surface.

In one embodiment the drying device 80 may include at least one infrared heating device 82.

In one embodiment the drying device 80 may include a heated conveyor device 86 configured to transport and dry the array of blanks of cellulose products downstream of the spraying device 78. The heated conveyor device 86 may be a belt conveyor having a heated belt.

The spraying device 78 and drying device 80 may be located downstream of the zone where the first and second tissue paper layers 40, 42 are applied to the array of blanks of cellulose products.

The apparatus 10 may include a pressing unit 44 and/or an embossing unit 46 configured to perform in-phase pressing and/or embossing of the blanks of products downstream of the detachment wheel 34. The in-phase pressing and/or embossing of discrete blanks of cellulose products may facilitate the initiation of folding lines in the blanks of cellulose products when these blanks are inserted into molds for forming the final products and are useful for ensuring repeatability and precision of the molding phase.

The spraying device 78 and drying device 80 may be located upstream or downstream of the pressing unit 44 and embossing unit 46.

In the embodiment of FIG. 1, the spraying device 78 and drying device 80 are arranged between the pressing unit 44 and the embossing unit 46.

In one embodiment the apparatus may include a cutting unit 58 configured to cut the array of blanks of cellulose products to form discrete blanks of cellulose products.

With reference to FIG. 2, in one embodiment the spraying device 78 and drying device 80 may be located downstream of the cutting unit 58. The spraying device 78 may be configured to perform indexed spraying of AKD aqueous solution in phase with discrete blanks of cellulose products formed downstream of the cutting unit 58. The intermittent application of AKD onto discrete blanks of cellulose products allows reducing the quantity of additive that would be wasted.

Downstream of the cutting unit 58, the discrete blanks of cellulose products are sent to subsequent process phases (e.g. hot pressing etc.) for transforming the blanks of cellulose products into finished products.

With reference to FIGS. 1 and 2, in one embodiment the apparatus 10 may include a sensor 88 configured to detect a parameter indicative of a dryness level of the array of blanks of cellulose products located downstream of the drying device 80. The apparatus 10 may include a control unit 90 configured to receive from the sensor 88 information about the dryness level of the array of blanks of cellulose products and to control the drying device 80 so as to achieve a predetermined dryness level in the array of blanks of cellulose products downstream of the drying device 80.

The control unit 90 may vary the operating temperature of the drying device 80 within a temperature range between 80° and 140°, both for contact drying and hot air drying. The control unit 90 may also vary the flow rate of hot air entering the drying device 80.

The temperature and air flow rate of the drying device 80 may be varied depending on production speed, characteristics of the blanks of cellulose products (dimensions and basis weight), and the quantity and type of additive.

In operation, the previously described apparatus 10 implements a method for dry forming of blanks of cellulose products comprising:
feeding a cellulose sheet 16 to an inlet section 14 of a defibrating mill 12 and providing a flow of loose cellulose fibers in an outlet section 18 of the defibrating mill 12,
sending the flow of loose cellulose fibers from the outlet section 18 of the defibrating mill 12 to a fiber deposition chamber 26,
providing a forming wheel 20 rotatable about a rotation axis and having an outer surface 22 provided with a plurality of discrete forming seats configured for forming blanks of cellulose products, wherein a sector of the outer surface faces the fiber deposition chamber,
dispensing at least one flow of AKD powder and transporting the AKD powder flow into the fiber deposition chamber 26 via at least one air flow, and
depositing loose cellulose fibers mixed with AKD powder into the discrete forming seats and forming discrete blanks of cellulose products including loose cellulose fibers mixed with AKD powder.

In one embodiment the method may include introducing at least one flow of AKD powder into the fiber deposition chamber 26 via at least one ejector 64.

In one embodiment the method may include:
feeding a cellulose sheet 16 to an inlet section 14 of a defibrating mill 12 and providing a flow of loose cellulose fibers in an outlet section 18 of the defibrating mill 12,
providing a forming wheel 20 rotatable about a rotation axis and having an outer surface 22 provided with a plurality of discrete forming seats configured for forming blanks of cellulose products,
sending the flow of loose cellulose fibers from the outlet section of the defibrating mill to a fiber deposition chamber facing a sector of the outer surface of the forming wheel and depositing loose cellulose fibers into the discrete forming seats so as to form discrete blanks of cellulose products including loose cellulose fibers,
sending an array of blanks of cellulose products from the forming wheel 20 to a transfer conveyor 74, and
applying molten AKD onto the array of blanks of cellulose products moving along the transfer conveyor 74.

In one embodiment the method may include applying molten AKD onto the array of blanks of cellulose products in continuous mode.

In one embodiment the method may include applying molten AKD onto the array of blanks of cellulose products in intermittent mode, in phase with discrete blanks of cellulose products.

In one embodiment the method may include cooling molten AKD applied onto the array of blanks of cellulose products.

In one embodiment the method may include:
feeding a cellulose sheet 16 to an inlet section 14 of a defibrating mill 12 and providing a flow of loose cellulose fibers in an outlet section 18 of the defibrating mill 12,
providing a forming wheel 20 rotatable about a rotation axis and having an outer surface 22 provided with a plurality of discrete forming seats configured for forming blanks of cellulose products,
sending the flow of loose cellulose fibers from the outlet section 18 of the defibrating mill 12 to a fiber deposition chamber 26 facing a sector of the outer surface 22 of the forming wheel 20 and depositing loose cellulose fibers into the discrete forming seats so as to form blanks of cellulose products including loose cellulose fibers,
spraying AKD in aqueous solution onto an array of blanks of cellulose products coming from the forming wheel 20, and
after the AKD aqueous solution spraying phase, drying the array of blanks of cellulose products to a predetermined dryness level.

In one embodiment the method may include drying the array of blanks of cellulose products using an infrared heating device 82 or a heated conveyor device.

In one embodiment the method may include detecting a parameter indicative of a dryness level of the array of blanks of cellulose products after the drying phase and controlling the drying phase based on the parameter indicative of a dryness level of the array of blanks of products so as to achieve a predetermined dryness level in the array of blanks of cellulose products downstream of the drying phase.

Naturally, while maintaining the principle of the invention, the construction details and embodiments may be widely varied with respect to what has been described and illustrated without thereby departing from the scope of the invention as defined by the following claims.

1. An apparatus for dry forming cellulose products comprising:
a defibrating mill having an inlet section configured to receive a cellulose sheet and an outlet section configured to provide a flow of loose cellulose fibers,
a fiber deposition chamber configured to receive said flow of loose cellulose fibers from said outlet section of said defibrating mill,
a forming wheel rotatable about a rotation axis and having an outer surface provided with a plurality of discrete forming seats configured for forming blanks of cellulose products, wherein a sector of said outer surface of the forming wheel faces said fiber deposition chamber so that in operation loose cellulose fibers are deposited in said plurality of discrete forming seats to form blanks of cellulose products including loose cellulose fibers,
a transfer conveyor configured to receive an array of blanks of cellulose products from said forming wheel, and
an applicator device configured to apply molten alkyl ketene dimer (AKD) onto said array of blanks of cellulose products moving along said transfer conveyor.

2. The apparatus of claim 1, wherein said applicator device is configured to apply the molten AKD onto said array of blanks of cellulose products in a continuous mode.

3. The apparatus of claim 1, wherein said applicator device is configured to apply the molten AKD onto said array of blanks of cellulose products in an intermittent mode, in phase with discrete blanks of the array of blanks of cellulose products.

4. The apparatus of claim 1, comprising a cooling device configured to cool the molten AKD applied onto said array of blanks of cellulose products.

5. The apparatus of claim 1, comprising a detachment wheel tangent to the outer surface of the forming wheel and rotatable about a rotation axis parallel to the rotation axis of the forming wheel, said detachment wheel configured to detach said blanks of cellulose products from respective discrete forming seats and to feed said blanks of cellulose products to said transfer conveyor.

6. The apparatus of claim 1, comprising first and second feeding devices configured to feed first and second tissue paper layers from opposite sides of said array of blanks of cellulose products downstream of said applicator device.

7. A method for dry forming cellulose products comprising:
feeding a cellulose sheet to an inlet section of a defibrating mill and providing a flow of loose cellulose fibers in an outlet section of the defibrating mill,
providing a forming wheel rotatable about a rotation axis and having an outer surface provided with a plurality of discrete forming seats configured for forming blanks of cellulose products,
sending said flow of loose cellulose fibers from said outlet section of said defibrating mill to a fiber deposition chamber facing a sector of said outer surface of the forming wheel and depositing loose cellulose fibers into said plurality of discrete forming seats so as to form blanks of cellulose products including loose cellulose fibers,
sending an array of the blanks of cellulose products from said forming wheel to a transfer conveyor, and
applying molten alkyl ketene dimer (AKD) onto said array of blanks of cellulose products moving along said transfer conveyor.

8. The method of claim 7, comprising applying the molten AKD onto said array of blanks of cellulose products in a continuous mode.

9. The method of claim 7, comprising applying the molten AKD onto said array of blanks of cellulose products in an intermittent mode, in phase with discrete blanks of the array of blanks of cellulose products.

10. The method of any of claim 7, comprising cooling the molten AKD applied onto said array of blanks of cellulose products.
